(19) United States
(12) Patent Application Publication
(10) Pub. No.: US 2020/0067393 A1
(43) Pub. Date: Feb. 27, 2020

(54) ACTUATOR AND ELECTRONIC DEVICE

(71) Applicant: NIDEC COPAL CORPORATION, Tokyo (JP)

(72) Inventors: Satoru ISHIKAWA, Tokyo (JP); Yoshihide TONOGAI, Tokyo (JP)

(73) Assignee: NIDEC COPAL CORPORATION, Tokyo (JP)

(21) Appl. No.: 16/551,135

(22) Filed: Aug. 26, 2019

(30) Foreign Application Priority Data
Aug. 27, 2018 (JP) 2018-157960

(51) Int. Cl. H02K 33/06; G06F 3/01

(52) U.S. Cl. CPC H02K 33/06; G06F 3/03547; G06F 3/016

(57) ABSTRACT

The actuator includes a stationary portion that has a permanent magnet; a movable portion, having a coil, that can move in respect to the stationary portion; an elastic member that is provided on a side of the movable portion in the movement direction; and a lead wire that is provided next to the elastic member, to supply electric power to the coil while bending.

### CROSS REFERENCE TO RELATED APPLICATION

This application claims priority to Japanese Application No. JP 2018-157960 filed Aug. 27, 2018. This application is incorporated herein by reference in its entirety.

### FIELD OF TECHNOLOGY

One aspect of the present invention relates to an actuator that is used in an electronic device, or the like.

### BACKGROUND

Many electronic devices, such as mobile terminals, and the like, have functions that cause the electronic device to vibrate, in order to inform the user of an incoming call that information has been received, or to communicate to the finger the sensation of having operated the touch panel. Such a function is achieved through the operation of an actuator, or the like, that is disposed within the electronic device. Such actuators are disclosed in, for example, Japanese Unexamined Patent Application Publication 2018-1108, Japanese Unexamined Patent Application Publication 2017-70018, and Japanese Unexamined Patent Application Publication 2011-72856.

### SUMMARY OF THE INVENTION

Actuators that have functions for causing electronic devices to vibrate typically include a stationary portion; a movable portion that undergoes reciprocating motion along an axial direction in respect to the stationary portion; and a driving portion for driving the movable portion. In the actuators described in Patent Document 2018-1108 and 2017-70018, coils and permanent magnets are provided respectively in the stationary portions and movable portions, as the driving portions.

However, there are moving coil-type actuators, such as the actuator described in Patent Document 2011-72856, wherein the coil and the permanent magnet are disposed, respectively, on the movable portion and the stationary portion, as the driving portion. For example, when a current is supplied through a lead wire to a coil that is undergoing reciprocating motion, there is the need for a structure that causes the lead wire to follow the coil, and also the need to achieve a strong vibration by increasing the mass of the movable portion. That is, in an actuator wherein the coil is provided on the movable portion, a technology is needed that enables the lead wire that supplies electric power to the coil to follow the coil well, while increasing the mass of the movable portion.

The present invention adopts means such as the following in order to solve the problem described above. Note that while in the explanation below, reference symbols from the drawings are written in parentheses for ease in understanding the present invention, the individual structural elements of the present invention are not limited to those that are written, but rather should be interpreted broadly, in a range that could be understood technically by a person skilled in the art.

One means according to the present invention is an actuator having a stationary portion that has permanent magnets; a movable portion, having a coil, that can move in respect to the stationary portion; an elastic member that is provided on a side of the movable portion in the movement direction (the z axial direction); and lead wires that are provided next to the elastic member, to supply electric power to the coil while bending.

The actuator of the configuration described above enables absorption of the vibration, through changing the degree of bend of the lead wires through following the coil of the movable portion, despite vibration through a portion of the lead wire being pulled and pushed repetitively, enabling absorption of the vibration while suppressing the amount of deformation of the lead wires. Because the lead wires are provided next to the elastic member, the lead wires can be provided using effectively the space for the elastic deformation of the elastic member, preventing any reduction in freedom in design of the movable portion when securing the space for elastic deformation of the lead wires. This can enable, in an actuator wherein the coil is provided on the movable portion, the lead wire that supplies electric power to the coil to follow the coil well, while increasing the mass of the movable portion.

In the actuator described above, preferably the elastic member is a bent plate-shaped member.

The actuator of the configuration set forth above enables absorption of the vibrational energy of the movable portion in a smaller space, making it possible to reduce the size of the actuator.

In the actuator set forth above, preferably the lead wire is provided with the direction of bending of the lead wire matching the direction of the bending of the leaf spring.

In the actuator of the configuration set forth above, the leaf spring and the lead wire may be disposed nearer to each other when the leaf spring and lead wire are provided next to each other, thus enabling the lead wire to bend through using more effectively the space for the elastic deformation of the leaf spring. This enables more reliable prevention of reduction in freedom of design of the movable portion when securing the space for elastic deformation of the lead wire.

In the actuator set forth above, preferably the lead wire is provided so as to bend within the leaf spring.

In the actuator of the configuration set forth above, the space for elastic deformation of the lead wire is in the interior of the leaf spring, enabling bending of the lead wire using more effectively the space for the elastic deformation of the leaf spring. This enables more reliable prevention of reduction in freedom of design of the movable portion when securing the space for elastic deformation of the lead wire.

In actuator set forth above, preferably the leaf spring has a bend portion of the plate-shaped member; a first end that is secured to the stationary portion; a second end that is secured to the movable portion; a first extending portion that extends from the first end toward the bend portion; and a second extending portion that extends from the second end toward the bend portion. Where the lead wire is provided along the second extending portion.

In the actuator of the configuration described above, the lead wire is provided along the second extending portion, wherein there is less deformation, enabling stabilization of the lead wire despite a portion of the lead wire undergoing vibration through being pulled and pushed repetitively following the coil of the movable portion.

The actuator set forth above preferably further has a lead wire for supplying electric power to the coil; and a substrate that has flexibility, and on which at least a portion of the lead wire is provided.

The actuator configured as described above enables the provision of the lead wires on a substrate that is, for example, an FPC (flexible printed circuit), enabling elastic deformation of the FPC and the lead wire while preventing entanglement. This enables the vibration to be absorbed while suppressing the amount of deformation of the FPC and the lead wire, despite a portion of the lead wire or the FPC vibrating through being pulled and pushed repetitively following the coil of the movable portion.

Any of the actuators set forth above may be applied suitably to an electronic device such as a personal computer, a smart phone, a tablet, or the like.

The electronic device of the configuration described above enables absorption of the vibration in the actuator through changing the degree of bend of the lead wire through following the coil of the movable portion, despite vibration through a portion of the lead wire being pulled and pushed repetitively, enabling absorption of the vibration while suppressing the amount of deformation of the lead wire. Because the lead wire is provided next to the elastic member, the lead wire can be provided using effectively the space for the elastic deformation of the elastic member, preventing any reduction in freedom in design of the movable portion when securing the space for elastic deformation of the lead wire. This can enable, in an actuator wherein the coil is provided on the movable portion, the lead wire that supplies electric power to the coil to follow the coil well, while increasing the mass of the movable portion. This enables a vibration of a greater vibrational strength to be applied to the electronic device, enabling an improvement in the feeling of having operated the electronic device.

### BRIEF DESCRIPTIONS OF THE DRAWINGS

FIG. 1 is a perspective diagram of a linear motor according to the present example.

FIG. 2 is a front view of the linear motor according to the present example.

FIG. 3 is a cross-sectional diagram at the position of the section III-III of FIG. 2 of the linear motor in the present example.

FIG. 4 is a cross-sectional diagram at the position of the section IV-IV of FIG. 2 of the linear motor in the present example.

FIG. 5 is a cross-sectional diagram at the position of the section V-V of FIG. 2 of the linear motor in the present example.

FIG. 6 is a cross-sectional drawing of the linear motor according to the present example.

FIG. 7 is a perspective diagram of a linear motor according to the present example.

FIG. 8 is a perspective diagram of a mobile information terminal according to the present example.

### DETAILED DESCRIPTION

In the actuator according to the present invention, in the configuration comprising a stationary portion that includes a permanent magnet, a movable portion that has a coil, and that is able to move in respect to the stationary portion and an elastic member that is provided on the movable portion on a movement direction side, the lead wire is next to the elastic member while bending and supplying electric power to the coil.

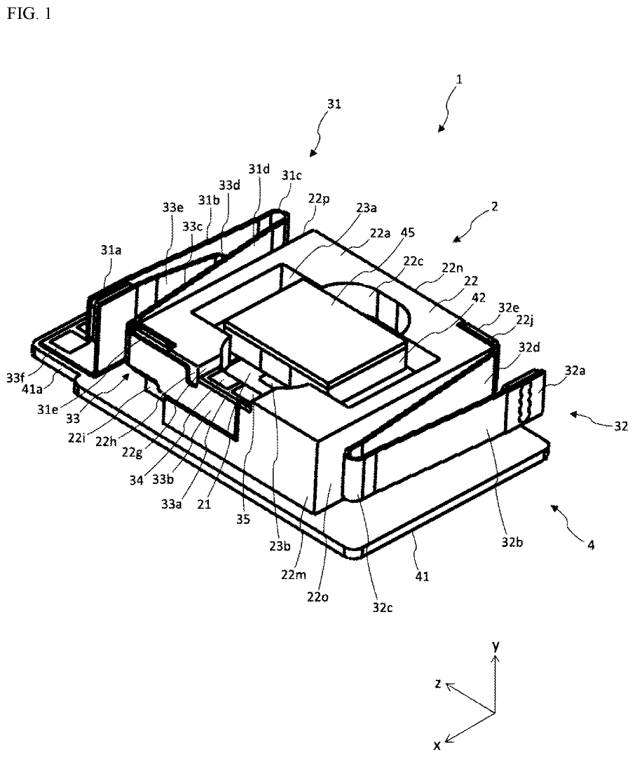

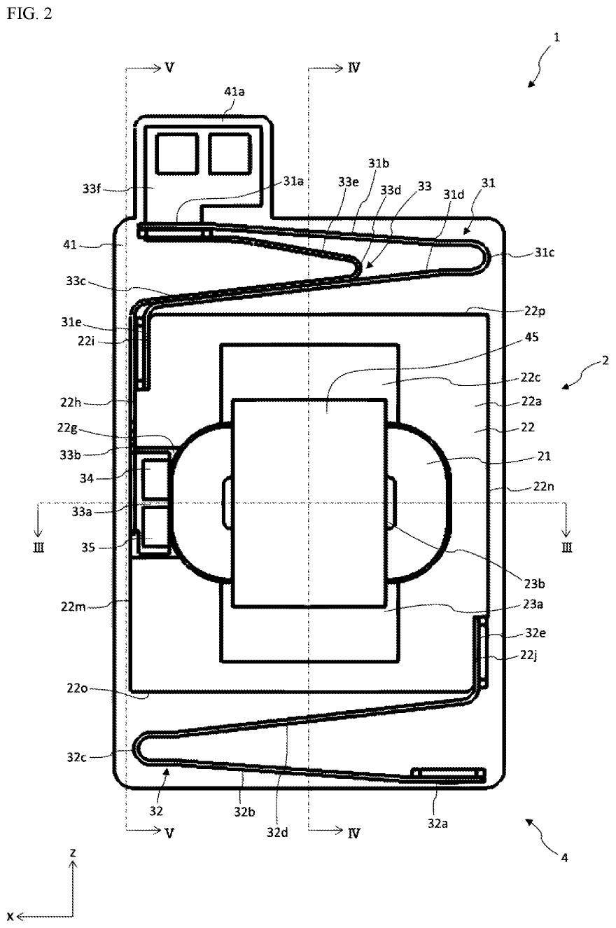

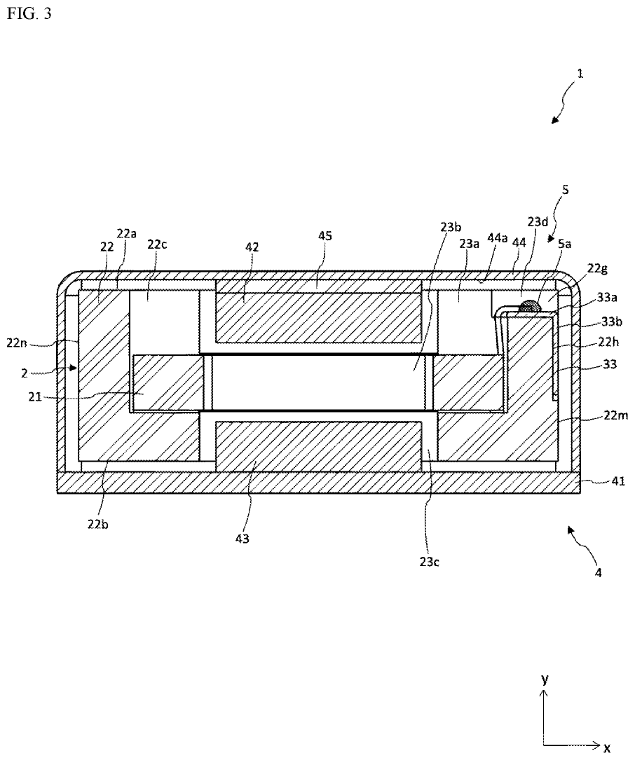

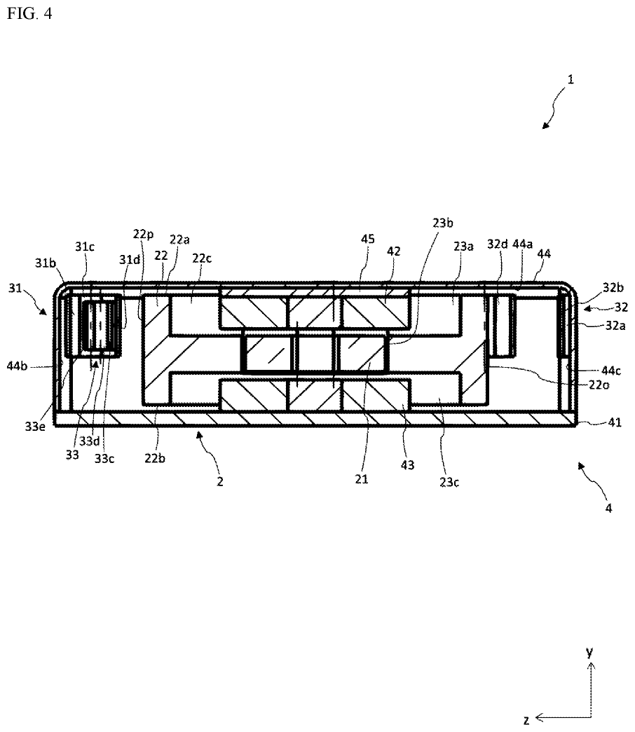

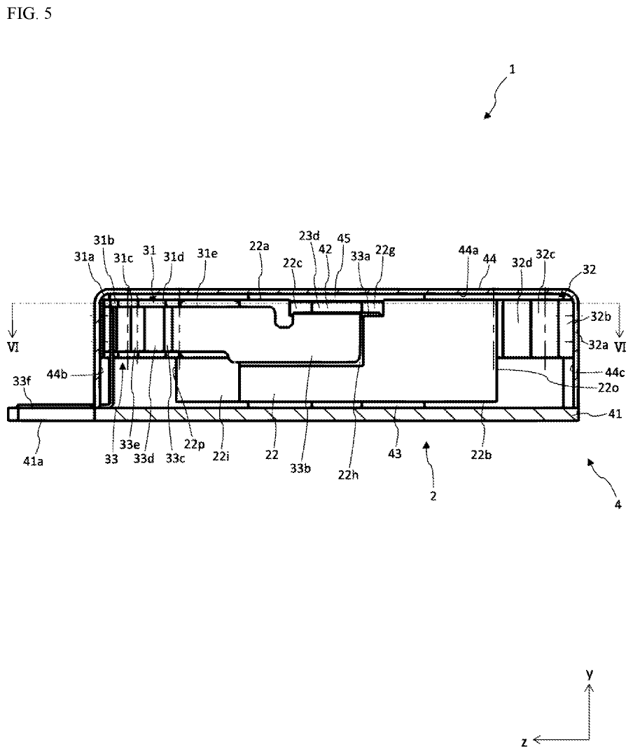

An example according to the present invention will be explained, following the structures below. However, the example explained below is no more than an example of the present invention, and must not be interpreted as limiting the technical scope of the present invention. Note that in the various drawings, identical reference symbols are assigned to identical structural elements, and explanations thereof may be omitted. Examples according to the present invention will be explained in reference to the drawings. FIG. 1 is a perspective diagram of a linear motor according to the present example. FIG. 2 is a front view of the linear motor according to the present example. FIG. 3 is a cross-sectional diagram at the position of the section III-III of FIG. 2 of the linear motor in the present example. FIG. 4 is a cross-sectional diagram at the position of the section IV-IV of FIG. 2 of the linear motor in the present example. FIG. 5 is a cross-sectional diagram at the position of the section V-V of FIG. 2 of the linear motor in the present example. Note that the case 44 is not illustrated in FIG. 1 and FIG. 2. The connecting portion 5 is not illustrated in FIG. 1, FIG. 2, and FIG. 5.

The x axis, the y axis, and the z axis are shown in each drawing. The axis that is parallel to the direction of movement of the movable portion 2 (hereinafter termed the “movement direction”) that, when viewed from the direction from the leaf spring 32 that is not provided on the FPC 33, is toward the leaf spring 31 that is provided on the FPC 33, is defined as the “z axis.” The axis that is perpendicular to the z axis and that is in the direction of the groove 22 g when viewed from the driving magnet 42 is defined as the “x axis.” Moreover, the axis that is perpendicular to both the z axis and the x axis, and that, when viewed from the driving magnet 43, is in the direction of the driving magnet 42, is defined as the “y axis.” Here the x axis, the y axis, and the z axis form right-handed three-dimensional Cartesian coordinates. In the below, the direction of the arrow for the z axis may be termed the “z-axial positive side” and the opposite direction may be termed the “z-axial negative side,” with the same for the other axes as well.
<Linear Motor 1>

As depicted in FIG. 1 through FIG. 5, a linear motor 1 according to the present example is structured including a movable portion 2, leaf springs 31 and 32, a stationary portion 4, a connecting portion 5, and an FPC 33. The linear motor 1 is attached to an electronic device such as, for example, a smart phone, a tablet, a laptop computer (notebook PC), a game controller, or the like. The linear motor 1 is one specific example of an “actuator” in the present invention.
<Stationary Portion 4>

The stationary portion 4 is configured including a base plate 41, driving magnets 42 and 43, a case 44, and a back yoke 45. The stationary portion 4 functions as a stationary portion that is secured to the electronic device.
<Base Plate 41>

The base plate 41 is a plate-shaped member that has an essentially rectangular cross-section, having a first face that faces toward the y-axial positive side and a second face that faces toward the y-axial negative side. In the present example, the base plate 41 is formed from a ferromagnetic material such as iron, to prevent the magnetic flux from the driving magnet 43, and the like, from leaking to the outside of the stationary portion 4. A protruding portion 41a, for protruding in the z-axial positive side is provided on the end portion of the base plate 41 on the z-axial positive side.
<Case 44>

The case 44 is a member that, together with the base plate 41, forms the case for the linear motor 1, and is formed from a resin, a metal, or the like (referencing FIG. 1 through FIG. 3). In the case 44, the y-axial negative side has a recessed shape that is open, to enable coupling with the base plate 41. The case 44 and the base plate 41 are connected to form a space for containing the movable portion 2, the leaf springs 31 and 32, the connecting portion 5, the FPC 33, the driving magnets 42 and 43, along with the back yoke 45, and the like. Here the inner surface of the case 44 that faces the direction of the base plate 41 that faces the y-axial positive side is defined as the bottom face 44a (referencing FIG. 3 through FIG. 5).
<Back Yoke 45>

The back yoke 45 is a plate-shaped member that has essentially the same cross-section as the cross-section of the driving magnet 42, and has a first face that in the direction of the y-axial positive side and a second face in the direction of the y-axial negative side. In the present example, the back yoke 45 is formed from a ferromagnetic material such as iron, to prevent magnetic flux, from the driving magnet 42, and the like, from leaking to the outside of the stationary portion 4. The back yoke 45 is secured to the case 44 through, for example, adhesive bonding of the first face to essentially the center of the bottom face 44a of the case 44. Driving magnets 42 and 43 are one specific example of “permanent magnets” in the present invention.
<Driving Magnets 42 and 43>

The driving magnets 42 and 43 face each other, with the coil 21 therebetween. In the present example, the driving magnet 42 is a plate-shaped permanent magnet, and has a first face in the direction of the y-axial positive side, and a second face in the direction of the y-axial negative side. The driving magnet 42 is secured to the stationary portion 4. In the present example, the driving magnet 42 is secured to the case 44 through adhesively bonding the first face to the second face of the back yoke 45 in a state wherein the side face of the driving magnet 42 is positioned aligned with the side face of the back yoke 45, for example.

The driving magnet 43 is a plate-shaped permanent magnet that has essentially the same shape as the driving magnet 42, and has a first face in the direction of the y-axial positive side and a second face in the direction of the y-axial negative side. The driving magnet 43 is secured to the stationary portion 4 so as to face the driving magnet 42 with the coil 21 therebetween. In the present example, the driving magnet 42 is, for example, secured to the base plate 41 through adhesive bonding of the second face to essentially the center of the y-axial positive side face of base plate 41.
<Movable Portion 2>

The movable portion 2 is structured including the coil 21 and the weight 22. The movable portion 2 is able to move along the movement direction in respect to the stationary portion 4.
<Weight 22>

The weight 22 is a ring-shaped member with an outer shape that is essentially rectangular, having a flat portion that faces the stationary portion 4. Specifically, the weight 22 is formed from a high density material, such as, for example, tungsten. The weight 22 has a first face 22a in the direction of the y-axial positive side, facing the bottom face 44a of the case 44, and a second face 22b, in the direction of the y-axial negative side, facing the first face of the base plate 41. There is a gap of a prescribed interval between the bottom face 44a and the first face 22a. There is a gap of a prescribed interval between the first face of the base plate 41 and the second face 22b. The weight 22 is one specific example of a “weight portion” in the present invention.

A through hole 22c that is parallel to the y axis is formed in essentially the center of the first face 22a of the weight 22. An escape space 23a, a storing space 23b, and an escape space 23c are formed continuously, from the y-axial positive side to the y-axial negative side, in the through hole 22c (referencing FIG. 3 and FIG. 4).

The escape space 23c is a space able to contain the driving magnet 43 that protrudes into the through hole 22c from the base plate 41 toward the y-axial positive side. Specifically, the escape space 23c has a cross-section that will not physically interfere with the weight 22 or the driving magnet 43 despite the weight 22 undergoing reciprocating motion. The storing space 23b has a space that is able to contain the coil 21. Specifically, the cross-section of the storing space 23b is slightly larger than the cross-section of the coil 21. The escape space 23a is a space able to contain the driving magnet 42 that protrudes into the through hole 22c from the bottom face 44a of the case 44 in the direction of the y-axial negative side. Specifically, the escape space 23a enables the coil 21 to pass therethrough, and has a cross-section that does not physically interfere with the weight 22 or the driving magnet 42 despite the weight 22 undergoing reciprocating motion.

A groove 22g for connecting the through hole 22c and the first face 22a of the weight 22 is provided on the first face 22a. The direction in which the groove 22g extends is perpendicular to the movement direction of the movable portion 2. Specifically, the groove 22g is formed through forming the x-axial positive side of the through hole 22c, to have a squared groove cross-section, extending in parallel to the x axis. The groove 22g connects the escape space 23a and the side face 22m of the weight 22 on the x-axial positive side. In a state went assembled together with the case 44 and the base plate 41, an introduction space 23d that connects between the outside of the weight 22 and the through hole 22c is formed between the bottom face 44a of the case 44 and the weight 22 (referencing FIG. 3 and FIG. 5).

At the side face 22m, at the end portion on the z-axial positive side, a stepped portion 22i is formed spanning from the first face 22a to the second face 22b. The step difference between the side face 22m and the stepped portion 22i is slightly greater than the total of the thickness of the leaf spring 31 and the thickness of the FPC 33. Moreover, at the side face 22m, at the end portion of the y-axial positive side, a stepped portion 22h is formed so as to be continuous from the groove 22g to the stepped portion 22i. The step difference between the side face 22m and the stepped portion 22h is slightly larger than the thickness of the FPC 33.

At the side face 22n on the x-axial negative side of the weight 22, at the end portion on the z-axial negative side, a stepped portion 22j is formed spanning from the first face 22a to the second face 22b. The step difference between the side face 22n the stepped portion 22j is slightly greater than the thickness of the leaf spring 32.
<Coil 21>

The coil 21 is provided on the inside of the through hole 22c. Specifically, the coil 21 is provided in the storing space 23b in the through hole 22c, and has a ring shape. The coil 21 has a first face in the direction of the y-axial positive side, facing the second face of the driving magnet 42, and a second face in the direction of the y-axial negative side, facing the first face of the driving magnet 43. A gap, of a prescribed interval, is provided between the first face of the coil 21 and the second face of the driving magnet 42. A gap of a prescribed interval is provided between the first face of the driving magnet 43 and the second face of the coil 21. The coil 21 is formed through winding, in a prescribed winding direction, a single wire (hereinafter sometimes termed a “winding”) that has a first end and a second end.
<Leaf Spring 31>

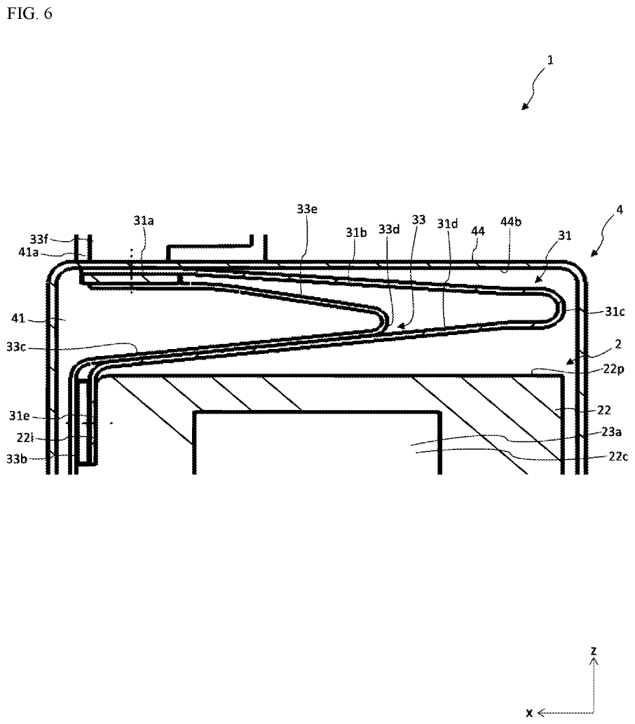

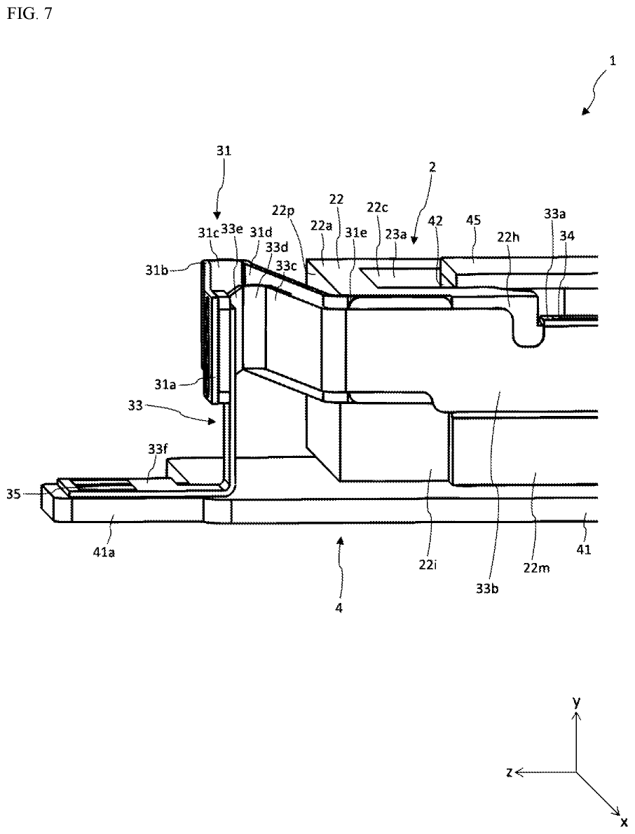

FIG. 6 is a cross-sectional drawing of a linear motor according to the present example. FIG. 7 is a perspective diagram of a linear motor according to the present example. FIG. 6 depicts a cross-sectional drawing along the section VI-VI in FIG. 5. FIG. 6 and FIG. 7 depict enlarged views of the z-axial positive side, in respect to the weight 22. Note that the case 44 is not shown in FIG. 7. Additionally, the connecting portion 5 is not shown in FIG. 7. As depicted in FIG. 1 through FIG. 7, the leaf spring 31 is provided on the moving direction side of the movable portion 2. The leaf spring 31 is one specific example of “elastic members” in the present invention.

The leaf spring 31 is provided on the z-axial positive side in respect to the movable portion 2. Specifically, the leaf spring 31 is provided between the z-axial positive side inner peripheral surface 44b of the case 44 (referencing FIG. 4 through FIG. 6) and the weight 22. The leaf spring 31 is structured including a first end 31a, extending portions 31b and 31d, a U-shaped portion 31c, and a second end 31e. The leaf spring 31 has a shape wherein a single plate-shaped member is bent, where the first end 31a, the extending portion 31b, the U-shaped portion 31c, the extending portion 31d, and the second end 31e are continuous sequentially. The U-shaped portion 31c is one specific example of a “bend portion” in the present invention.

The first end 31a is secured to a stationary portion 4. The second end 31e is secured to the movable portion 2. In the U-shaped portion 31c, a plate-shaped member is shaped through bending back into a U shape. The extending portion 31b extends from the first end 31a toward the U-shaped portion 31c. The extending portion 31d extends from the second end 31e toward the U-shaped portion 31c.

Specifically, the first end 31a is secured to the x-axial positive side of the inner peripheral surface 44b of the case 44. The extending portion 31b is connected to the first end 31a, and is extended so as to be near to the side face 22p, while facing toward the x-axial negative side. The U-shaped portion 31c is connected to the extending portion 31b at the end portion on the z-axial positive side, to convert the direction of extension of the plate-shaped member of the leaf spring 31 to the x-axial positive side, while nearing the side face 22p. The extending portion 31d is connected to the end portion of the U-shaped portion 31c on the z-axial negative side, and extends so as to approach the side face 22p while directed toward the x-axial positive side. The second end 31e is connected to the extended portion 31d through the dotted lines that are parallel to the y axis, at the connecting part of the side face 22p and the stepped portion 22i in the weight 22, and secured to the stepped portion 22i of the weight 22.

In this way, the second end 31e is secured to the stepped portion 22i, enabling the leaf spring 31 to increase the mass of the weight 22 while preventing it from extending beyond the side face 22m of the weight 22. The leaf spring 31 provides a force of restitution to the weight 22 that is moving, through deformation of the shape based on the movement of the weight 22, along the movement direction.
<Leaf Spring 32>

The leaf spring 32 is provided on the z-axial negative side in respect to the movable portion 2. Specifically, the leaf spring 32 is provided between the z-axial negative side inner peripheral surface 44c of the case 44 (referencing FIG. 4 through FIG. 6) and the weight 22. The leaf spring 32 is structured including a first end 32a, extending portions 32b and 32d, a U-shaped portion 32c, and a second end 32e. The leaf spring 32 has a shape wherein a single plate-shaped member is bent, where the first end 32a, the extending portion 32b, the U-shaped portion 32c, the extending portion 32d, and the second end 32e are continuous sequentially.

Specifically, the first end 32a is secured to the x-axial negative side of the inner peripheral surface 44c of the case 44. The extending portion 32b is connected to the first end 32a, and is extended so as to be near to the side face 22o, while facing toward the x-axial positive side. The U-shaped portion 32c is connected to the extending portion 32b at the end portion on the z-axial negative side, to convert the direction of extension of the plate-shaped member of the leaf spring 32 to the x-axial negative side, while nearing the side face 22o. The extending portion 32d is connected to the end portion of the U-shaped portion 32c on the z-axial positive side, and extends so as to approach the side face 22o while directed toward the x-axial negative side. The second end 32e is connected to the extended portion 32d through the dotted lines that are parallel to the y axis, at the connecting part of the side face 22o and the stepped portion 22j in the weight 22, and secured to the stepped portion 22j of the weight 22.

In this way, the second end 32e is secured to the stepped portion 22j, enabling the leaf spring 32 to increase the mass of the weight 22 while preventing it from extending beyond the side face 22n of the weight 22. The leaf spring 32 provides a force of restitution to the weight 22 that is moving, through deformation of the shape based on the movement of the weight 22, along the movement direction.
<FPC 33>

The FPC 33 is a substrate that has flexibility, and includes the lead wires 34 and 35 for supplying electric power to the coil 21. The FPC 33 is structured including terminal portions 33a and 33f, extending portions 33b, 33c, and 33e, and also bend portion 33d. The FPC 33 is structured including the terminal portion 33a, the extending portion 33b, the extending portion 33c, the bend portion 33d, the extending portion 33e, and the extending portion 33f sequentially continuously.

The lead wires 34 and 35 are straight members that are formed from metal with high electrical conductivity, and are routed on the FPC 33 during coating. In the present example, the lead wire 34 has a first end that is exposed at a terminal portion 33a, and a second end that is exposed at a terminal portion 33f, and is a copper film that is formed through patterning on the FPC 33. The lead wire 35 has a first end that is exposed at a terminal portion 33a, and a second end that is exposed at a terminal portion 33f, and is a copper film that is formed through patterning on the FPC 33.

The FPC 33 is provided bent next to the leaf spring 31. In the present example, the FPC 33 is provided so that the direction of bending of the FPC 33 conforms to the direction of bending of the leaf spring 31, in the interior of the leaf spring 31. Moreover, the FPC 33 is provided so as to bend in the interior of the leaf spring 31.

Specifically, the terminal portion 33a has a surface that is parallel to the zx plane, and is provided on the bottom face of the groove 22g of the weight 22. The extending portion 33b has a surface that is parallel to the yz plane, and is provided so as to contact the second end 31e of the leaf spring 31 and the stepped portion 22h. The extending portion 33b is connected with the terminal portion 33a through the dotted lines that are parallel to the z axis, in the connecting part between the groove 22g of the weight 22 and the stepped portion 22h, and extends in the direction of the z-axial positive side.

The extending portion 33c is provided so as to run along the extending portion 31d of the leaf spring 31. In the present example, the extending portion 33c is connected to the extending portion 33b through the dotted lines that are parallel to the y axis, to extend while in contact with the z-axial positive side face of the extending portion 31d of the leaf spring 31. Specifically, the extending portion 33c is connected to the extending portion 33b through the dotted lines, and extends so as to be directed toward the x-axial negative side, and to be away from the side face 22p.

The bend portion 33d is positioned between the extending portion 31b and the extending portion 31d of the leaf spring 31. The bend portion 33d is connected to the extending portion 33c that the z-axial negative side end portion, to convert the direction of extension of the FPC 33 to be toward the x-axial positive side, while being away from the side face 22p.

The extending portion 33e is connected to the end portion of the bend portion 33d on the z-axial positive side, and extends so as to be away from the side face 22p, directed toward the x-axial positive side. The terminal portion 33f has a surface that is parallel to the zx plane, and is connected to the extending portion 33e through the dotted lines that are parallel to the x axis, and is provided on the protruding plate 41a of the base plate 41.
<Connecting Portion 5>

The connecting portion 5 is positioned in the groove 22g, and connects the lead wires 34 and 35 to the coil 21. In the present example, the connecting portion 5 not only connects the first end of the winding of the coil 21 and the first end of the lead wire 34, but also connects the second end of the winding of the coil 21 and the first end of the lead wire 35. Specifically, the connecting portion 5 is provided in the introduction space 23d that is formed between the groove 22g and the bottom face 44a of the case 44. In the introduction space 23d, at the terminal portion 33a the first end of the winding of the coil 21 and the first end of the lead wire 34 are connected electrically through solder (not shown), and the second end of the winding of the coil 21 is connected electrically to the first end of the lead wire 35 through solder 5a (referencing FIG. 3). In this way, the connecting portion 5 is provided in the introduction space 23d, where the solder buildup is contained within the introduction space 23d, making possible to reduce the possibility of contact between the solder and the case 44. Note that in the connecting portion 5, the first end of the winding of the coil 21 may be connected to the first end of the lead wire 35 with the second end of the winding of the coil 21 connected to the first end of the lead wire 34.
<Mobile Information Terminal 100>

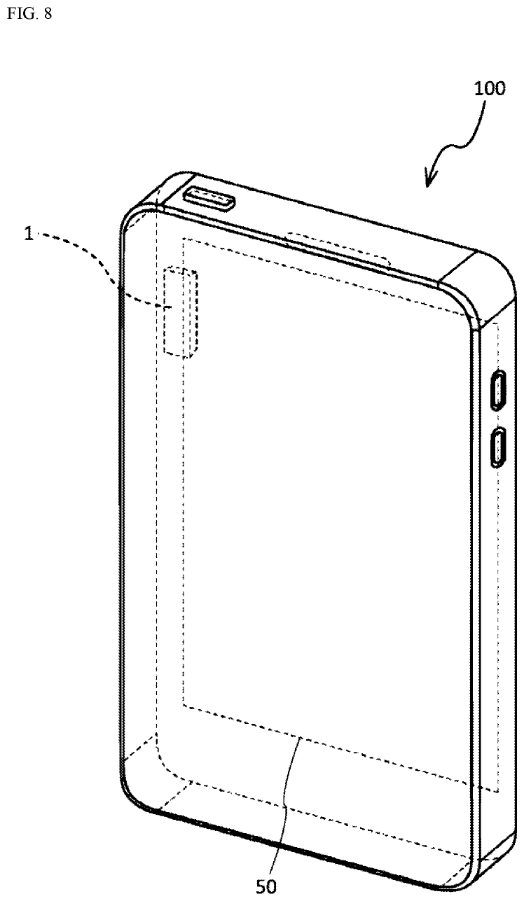

FIG. 8 is a perspective diagram of a mobile information terminal according to the present example. The mobile information terminal 100 is structured including a linear motor 1 and a touch operating panel 50. The mobile information terminal 100 is a consumer electronics product comprising the touch operating panel 50. Specifically, the mobile information terminal 100 is, for example, a smart phone. Note that the mobile information terminal 100 may instead be a tablet, a laptop computer, a game controller, or the like. The mobile information terminal 100 is one specific example of an “electronic device” in the present invention.

The touch operating panel 50 is, for example, a touch display. The mobile information terminal 100 is structured to cause the linear motor 1 to vibrate in response to a touch operation on the touch operating panel 50. The linear motor 1 has a large mass on the movable portion 2, and thus has good vibrational characteristics. Through this, good responsiveness can be achieved, even when repetitively starting and stopping vibration of the mobile information terminal 100, corresponding to repetitive brief touch operations. The touch operating panel 50 may have a configuration that is a touchpad. Moreover, the configuration may be one wherein the linear motor 1 is provided in an electronic device that does not have a touch operating panel 50.

The linear motor of the configuration described above enables absorption of the vibration, through changing the degree of bend of the lead wires 34 and 35 through following the coil 21 of the movable portion 2, despite vibration through portions of the lead wires 34 and 35 being pulled and pushed repetitively, enabling absorption of the vibration while suppressing the amount of deformation of the lead wires 34 and 35. Because the lead wires 34 and 35 are provided next to the elastic member, the lead wires 34 and 35 can be provided using effectively the space for the elastic deformation of the elastic member, preventing any reduction in freedom in design of the movable portion 2 when securing the space for elastic deformation of the lead wires 34 and 35. This can enable, in a linear motor 1 wherein the coil 21 is provided on the movable portion 2, the lead wires 34 and 35 that supply electric power to the coil 21 to follow the coil 21 well, while increasing the mass of the movable portion 2.

The linear motor configured as described above the elastic member is a leaf spring 31 wherein a plate-shaped member is bent, enabling absorption of the vibrational energy of the movable portion 2 in a smaller space, making it possible to reduce the size of the linear motor 1.

In the linear motor of the configuration set forth above, the leaf spring 31 and the lead wires 34 and 35 may be disposed nearer to each other when the leaf spring 31 and lead wires 34 and 35 are provided next to each other, because the direction of bending of the leaf spring 31 and direction of bending of the lead wires 34 and 35 are the same. Through this, the lead wires 34 and 35 can bend using, more effectively, the space for elastic deformation of the leaf spring 31, preventing any reduction in freedom in design of the movable portion 2 when securing the space for elastic deformation of the lead wires 34 and 35.

In the linear motor of the configuration set forth above, the lead wires 34 and 35 are provided so as to bend within the interior of the leaf spring 31, enabling the space for elastic deformation of the wires 34 and 35 to be included in the interior of the leaf spring 31, enabling bending of the lead wires 34 and 35 using more effectively the space for the elastic deformation of the leaf spring 31. This enables more reliable prevention of reduction in freedom of design of the movable portion 2 when securing the space for elastic deformation of the lead wires 34 and 35.

In the linear motor of the configuration set forth above, the leaf spring 31 is structured including a U-shaped portion 31c, a first end 31a that is secured to a case 44, a second end 31e that is secured to the movable portion 2, an extending portion 31b that extends from the first end 31a toward the U-shaped portion 31c, and extending portion 31d that extends from the second end 31e toward the U-shaped portion 31c, where the lead wires 34 and 35 run along the extending portion 31d. Through this, the lead wires 34 and 35 are provided along the extending portion 31d, wherein there is less deformation, enabling stabilization of the lead wires 34 and 35 despite portions of the lead wires 34 and 35 undergoing vibration through being pulled and pushed repetitively following the coil 21 of the movable portion 2.

The linear motor of the configuration set forth above enables the provision of the lead wires 34 and 35, for supplying electric power to the coil, on a substrate that has flexibility, such as, for example, providing the lead wires 34 and 35 on the substrate of an FPC 33, enabling the FPC 33 and the lead wires 34 and 35 to deform elastically while preventing entanglement of the lead wires 34 and 35. This enables the vibration to be absorbed while suppressing the amount of deformation of the FPC 33 and the lead wires 34 and 35, despite a portion of the lead wires 34 and 35 or the FPC 33 vibrating through being pulled and pushed repetitively following the coil 21 of the movable portion 2. An example according to the present invention was explained in detail above. The explanation above is no more than an explanation of one form of example, and the scope of the present invention is not limited to this form of example, but rather is interpreted broadly, in a scope that can be understood by one skilled in the art.

While, in the actuator according the present example, the explanation was for a configuration wherein leaf springs 31 and 32 were one specific example of “elastic members,” the configuration may instead be one wherein other types of springs, such as coil springs, spiral springs, or the like, is the specific example of the “elastic members.”

Moreover, while in the actuator according to the present example the explanation was for a configuration wherein the lead wires 34 and 35 routed on the FPC 33 during coating, the configuration may instead be one wherein coated lead wires 34 and 35 are routed as-is.

While in the actuator according to the present example the explanation was for a configuration wherein the entirety of the lead wires 34 and 35 were connected on the FPC 33, the configuration may instead be one wherein a portion of the lead wires 34 and 35 are routed on the FPC 33.

The present invention can be used suitably as an actuator for causing vibrations in an electronic device such as a smart phone, a tablet, a laptop computer, a game controller, or the like.

1. An actuator comprising:
a stationary portion comprising a permanent magnet;
a movable portion, comprising a coil, that can move in respect to the stationary portion;
an elastic member provided on a side of the movable portion in the movement direction; and
a lead wire provided next to the elastic member, to supply electric power to the coil while bending.

2. The actuator as set forth in claim 1, wherein:
the elastic member is a bent plate-shaped member.

3. The actuator as set forth in claim 2, wherein:
the lead wire is provided with the direction of bending of the lead wire matching the direction of the bending of the leaf spring.

4. The actuator as set forth in claim 2, wherein:
the lead wire is provided so as to bend within the leaf spring.

5. The actuator as set forth in claim 2, wherein the leaf spring comprises:
a bend portion of the plate-shaped member;
a first end that is secured to the stationary portion;
a second end that is secured to the movable portion;
a first extending portion that extends from the first end toward the bend portion; and
a second extending portion that extends from the second end toward the bend portion,
wherein the lead wire is provided along the second extending portion.

6. The actuator as set forth in claim 1, further comprising:
a substrate that has flexibility, and on which at least a portion of the lead wire is provided.

7. An electronic device, comprising an actuator as set forth in claim 1.
